(19) United States
(12) Patent Application Publication
(10) Pub. No.: US 2009/0161255 A1
(43) Pub. Date: Jun. 25, 2009

(54) PERPENDICULAR MAGNETIC RECORDING MEDIUM AND MAGNETIC RECORDING/REPRODUCTION APPARATUS USING THE SAME

(75) Inventor: Tomoyuki Maeda, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/242,506

(22) Filed: Sep. 30, 2008

(30) Foreign Application Priority Data
Dec. 20, 2007 (JP) 2007-329075

(51) Int. Cl. G11B 5/127; G11B 5/667

(52) U.S. Cl. 360/110; 428/828.1; G9B/5.241; G9B/5.04

(57) ABSTRACT

According to one embodiment, a perpendicular magnetic recording medium includes a substrate, soft magnetic underlying layer, nonmagnetic underlying layer, and perpendicular magnetic recording layer. The perpendicular magnetic recording layer has an array of magnetic structures each corresponding to 1 bit of recording information, and includes a crystalline hard magnetic recording layer having perpendicular magnetic anisotropy, and an amorphous soft magnetic recording layer. The hard and soft magnetic recording layers are coupled by exchange coupling.

### CROSS-REFERENCE TO RELATED APPLICATIONS

This application is based upon and claims the benefit of priority from Japanese Patent Application No. 2007-329075, filed Dec. 20, 2007, the entire contents of which are incorporated herein by reference.

### BACKGROUND

1. Field

One embodiment of the present invention relates to a perpendicular magnetic recording medium for use in, e.g., a hard disk drive using the magnetic recording technique and, more particularly, to a patterned medium in which a magnetic recording layer has an array of magnetic structures each corresponding to 1 bit of recording information, and a magnetic recording/reproduction apparatus using the patterned medium.

2. Description of the Related Art

Magnetic memory devices (HDDs) mainly used in computers to record and reproduce information are recently beginning to be used in various applications because they have large capacities, inexpensiveness, high data access speeds, a high data retaining reliability, and the like, and they are now used in various fields such as household video decks, audio apparatuses, and automobile navigation systems. As the range of applications of the HDDs extends, demands for large storage capacities increase, and high-density HDDs are more and more extensively developed in recent years.

As a magnetic recording method of presently commercially available HDDs, a perpendicular magnetic recording method is recently rapidly finding widespread use as a technique replacing the conventional in-plane magnetic recording method. In the perpendicular magnetic recording method, magnetic crystal grains forming a magnetic recording layer for recording information have the axis of easy magnetization in the film thickness direction of the magnetic recording layer, i.e., in a direction perpendicular to a substrate. The axis of easy magnetization is an axis in the direction of which magnetization easily points. In a Co-based alloy, the axis of easy magnetization is the axis (c-axis) parallel to the normal of the (0001) plane of the hcp structure of Co. Even when the recording density is increased, therefore, the influence of a demagnetizing field between recording bits is small, and the medium is magnetostatically stable. A perpendicular magnetic recording medium generally comprises a substrate, a nonmagnetic underlying layer for orienting magnetic crystal grains in a perpendicular magnetic recording layer in the (0001) plane and reducing the orientation dispersion, the perpendicular magnetic recording layer containing a hard magnetic material, and a protective layer for protecting the surface of the perpendicular magnetic recording layer. In addition, a soft magnetic underlying layer for concentrating a magnetic flux generated from a magnetic head during recording is formed between the substrate and nonmagnetic underlying layer.

To increase the recording density of the perpendicular magnetic recording medium, noise must be reduced while a high thermal stability is maintained. A general noise reducing method is to reduce the magnetic interaction between the magnetic crystal grains in the recording layer by magnetically isolating the grains in the film surface, and decrease the size of the grains themselves at the same time. A practical example is a method of adding SiO₂ or the like to the recording layer, thereby forming a perpendicular magnetic recording layer having a so-called granular structure in which each magnetic crystal grain is surrounded by a grain boundary region mainly containing the additive. If noise is reduced by this method, however, it is inevitably necessary to increase the magnetic anisotropic energy (Ku) of the magnetic crystal grains, as the magnetization reversal volume reduces, in order to ensure a high thermal stability. If the magnetic anisotropic energy of the magnetic crystal grains is increased, however, a saturation magnetic field Hs and coercive force Hc also increase. Since this increases the recording magnetic field necessary for magnetization reversal for data write as well, the writability of a recording head decreases. As a consequence, the recording/reproduction characteristics deteriorate.

To solve this problem, a patterned medium is being studied. In this patterned medium, an array of magnetic structures each corresponding to 1 bit is formed in the perpendicular magnetic recording layer, e.g., magnetic dots are formed by micropatterning, and these magnetic dots are magnetically isolated. In the patterned medium, the magnetic crystal grains in the perpendicular magnetic recording layer need only be magnetically isolated such that magnetization is reversed not for every crystal grain but for every magnetic dot having a size corresponding to 1 bit and containing a few to a few ten magnetic crystal grains. This makes the magnetization reversal volume larger than that of the granular structure. Accordingly, the Ku value required to assure a high thermal stability can be decreased. This makes it possible to suppress the increases in Hs and Hc, and suppress a magnetic field (switching field) necessary for magnetization reversal.

On the other hand, in the patterned medium, a few to a few ten magnetic crystal grains contained in each magnetic dot must reverse magnetization almost magnetically coherently in order to prevent the generation of a reversed domain in the magnetic dot. Unlike in the granular structure described above, therefore, the perpendicular magnetic recording layer must be formed as a continuous film in each magnetic dot, thereby strengthening the magnetic interaction between the magnetic crystal grains. Unfortunately, if the magnetic interaction between the magnetic crystal grains is strengthened in a CoCrPt-based alloy material widely used as the perpendicular magnetic recording layer material of the existing perpendicular magnetic recording medium, the coercive force Hc and a nucleating magnetic field Hn generally significantly decrease to about a few hundred Oe, thereby generating a reversed domain by an external magnetic field, stray field, or thermal decay. As described in, e.g., “Applied Physics Letters”, vol. 90, page 162,516, therefore, an artificial lattice continuous film such as Co/Pd or Co/Pt is used in the fundamental study of a perpendicular magnetic recording layer for the patterned medium. These materials are continuous films in which the magnetic interaction between crystal grains is strong, and yet achieve an adequately large coercive force Hc and nucleating magnetic field Hn. Accordingly, the above-mentioned problem does not easily arise.

Unfortunately, the patterned medium has another problem. That is, the switching field distribution (SFD) for each magnetic dot must be minimized in order to allow a designated magnetic dot to reliably reverse magnetization with respect to a recording magnetic field having a preset intensity, and prevent magnetization reversal in adjacent dots. When using a crystalline perpendicular film in the patterned medium, one big cause of the SFD is an inter-dot crystal grain structure variation. That is, when a crystalline continuous film having a certain crystal grain size distribution is processed into dots, the numbers of crystal grains (including those cut by the processing) and the formation states of the grain boundary of the individual dots are not uniform. Since this makes the individual dot switching fields nonuniform, a large SFD is produced.

As described above, it is difficult for the conventional patterned medium to prevent the generation of a reversed domain in each magnetic dot and prevent the switching field variation between the magnetic dots at the same time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing an example of a perpendicular magnetic recording medium according to the present invention;

FIG. 2 is a graph exemplarily showing an example of a magnetization curve of a perpendicular magnetic recording layer;

FIG. 3 is a sectional view showing another example of the perpendicular magnetic recording medium according to the present invention;

FIG. 4 is a sectional view showing still another example of the perpendicular magnetic recording medium according to the present invention;

FIG. 5 is a partially exploded perspective view showing an example of a magnetic recording/reproduction apparatus of the present invention; and

FIG. 6 is a graph for explaining ΔHc and a method of evaluating it.

### DETAILED DESCRIPTION

Various embodiments according to the invention will be described hereinafter with reference to the accompanying drawings. In general, according to one embodiment of the invention, a perpendicular magnetic recording medium according to the present invention comprises a substrate, a soft magnetic underlying layer formed on the substrate, a nonmagnetic underlying layer formed on the soft magnetic underlying layer, and a perpendicular magnetic recording layer formed on the nonmagnetic underlying layer. This perpendicular magnetic recording layer has an array of magnetic structures (magnetic dots) each corresponding to 1 bit of recording information, and includes a crystalline hard magnetic recording layer having magnetic anisotropy in the film thickness direction, and an amorphous soft magnetic recording layer formed on the hard magnetic recording layer. The hard and soft magnetic recording layers are coupled by exchange coupling.

Also, a magnetic recording/reproduction apparatus according to the present invention comprises the magnetic recording medium described above, and a recording/reproduction head.

In the present invention, the magnetic recording layer having the magnetic dot array is formed by stacking the crystalline hard magnetic recording layer and amorphous soft magnetic recording layer. The use of the crystalline hard magnetic recording layer achieves an appropriate coercive force Hc and nucleating magnetic field Hn, and a high thermal decay resistance.

Also, stacking the amorphous soft magnetic recording layer on the hard magnetic recording layer can strengthen the exchange interaction between hard magnetic crystal grains through the soft magnetic recording layer. Since this allows the hard magnetic crystal grains in each magnetic dot to coherently reverse magnetization, no reversed domain is formed in the dot. Since the soft magnetic recording layer is amorphous, variations in crystal grain size and crystal orientation in the film surface, which are inevitable in a crystalline magnetic material, do not exist in principle. The soft magnetic recording layer like this and the hard magnetic recording layer described above are coupled by exchange coupling. Consequently, the switching field distribution, i.e., the SFD for each magnetic dot can be suppressed.

The SFD can be evaluated by using, e.g., the ΔHc/Hc evaluation method described in “IEEE Transaction on Magnetics”, vol. 27, page 4,975.

A protective layer, lubricant layer, and the like can be freely formed on the perpendicular magnetic recording layer as needed.

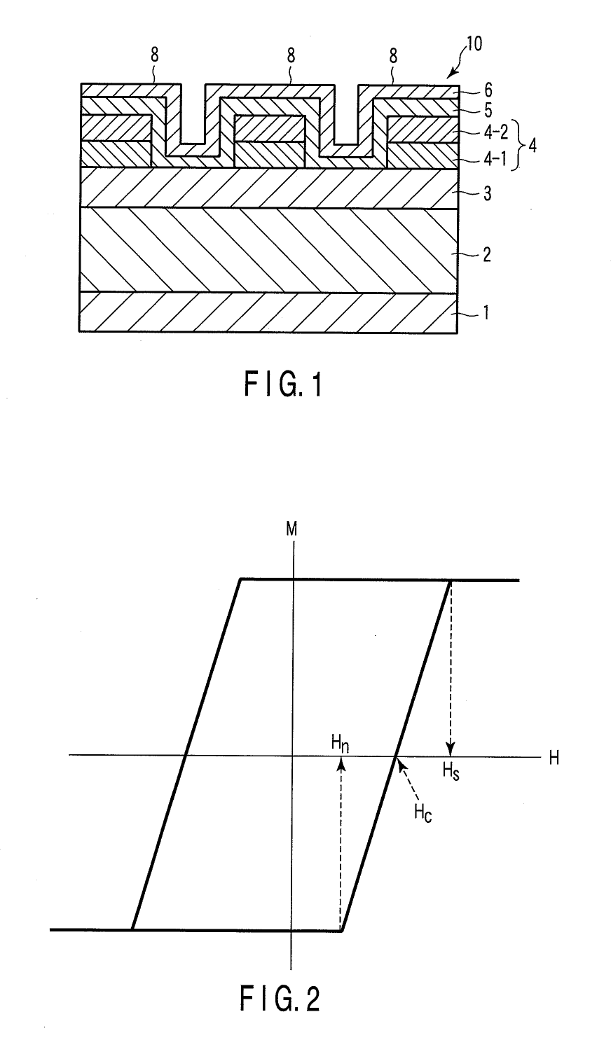

FIG. 1 is a sectional view showing an example of the perpendicular magnetic recording medium according to the present invention.

As shown in FIG. 1, a perpendicular magnetic recording medium 10 is obtained by sequentially stacking a soft magnetic underlying layer 2, nonmagnetic underlying layer 3, perpendicular magnetic recording layer 4, protective layer 5, and lubricating layer 6 on a substrate 1. The perpendicular magnetic recording layer 4 includes a hard magnetic recording layer 4-1 and soft magnetic recording layer 4-2. The perpendicular magnetic recording layer 4 is separated into magnetic dot units each corresponding to 1 bit of recording information, and has an array of projections 8. The magnetic dots are spaced apart from each other, and magnetically isolated.

As the nonmagnetic substrate of the present invention, it is possible to use, e.g., a glass substrate, an Al-based alloy substrate, an Si single-crystal substrate having an oxidized surface, ceramics, or plastic. The same effect can also be expected even when the surface of any of these nonmagnetic substrates is plated with an NiP alloy or the like.

A protective layer can be formed on the perpendicular magnetic recording layer of the present invention. Examples of the protective layer are C, diamond-like carbon (DLC), SiNₓ, SiOₓ, and CNₓ.

As the lubricant of the present invention, perfluoropolyether (PFPE) or the like can be used.

A so-called perpendicular double-layered medium is obtained by forming a high-permeability soft magnetic underlying layer between the nonmagnetic underlying layer and substrate. In this perpendicular double-layered medium, the soft magnetic underlying layer horizontally passes a recording magnetic field from a magnetic head such as a single pole head for magnetizing the perpendicular magnetic recording layer, and returns the recording magnetic field to the magnetic head, thereby performing a part of the function of the magnetic head. Thus, the soft magnetic underlying layer can increase the recording/reproduction efficiency by applying a steep sufficient perpendicular magnetic field to the magnetic field recording layer.

Examples of the soft magnetic layer are CoZrNb, CoB, CoTaZr, FeSiAl, FeTaC, CoTaC, NiFe, Fe, FeCoB, FeCoN, FeTaN, and CoIr.

The soft magnetic underlying layer may also be a multilayered film having two or more layers. In this case, the materials, compositions, and film thicknesses of the individual layers can be different. It is also possible to form a three-layered structure by sandwiching a thin Ru layer between two soft magnetic underlying layers. The film thickness of the soft magnetic underlying layer is appropriately adjusted to balance the overwrite (OW) characteristic with the signal-to-noise ratio (SNR).

It is also possible to form a bias application layer, such as an in-plane hard magnetic film or antiferromagnetic film, between the soft magnetic underlying layer and substrate. The soft magnetic layer readily forms a domain, and this domain generates spike noise. Therefore, a magnetic field is applied in one direction along the radial direction of the bias application layer, thereby applying a bias magnetic field to the soft magnetic layer formed on the bias application layer, and preventing the generation of a magnetic domain wall.

The bias application layer can also prevent easy formation of a large domain by finely dispersing the anisotropy. Examples of the bias application layer material are CoCrPt, CoCrPtB, CoCrPtTa, CoCrPtTaNd, CoSm, CoPt, FePt, CoPtO, CoPtCrO, CoPt—SiO₂, CoCrPt—SiO₂, CoCrPtO—SiO₂, FeMn, IrMn, and PtMn.

The soft magnetic underlying layer, nonmagnetic underlying layer, perpendicular magnetic recording layer, protective layer, and lubricant layer can be formed by any of vacuum evaporation, sputtering, chemical vapor deposition, and laser ablation.

As sputtering, it is possible to use, e.g., single-element sputtering using a composite target, or multi-element simultaneous sputtering using targets of different materials.

The Ku of L1₀ crystal grains used in the hard magnetic recording layer can be increased by raising the substrate temperature to 200° C. to 500° C. before and/or during the formation of the seed layer, underlying layer, or magnetic recording layer.

The perpendicular magnetic recording layer according to the present invention includes the hard and soft magnetic recording layers, and has the magnetic dot array structure.

Note that the coercive force Hc, saturation magnetic field Hs, and nucleating magnetic field Hn can be readily obtained from the magnetization curve (hysteresis loop) of the perpendicular magnetic recording layer.

FIG. 2 exemplarily shows an example of the magnetization curve of the perpendicular magnetic recording layer, and also shows the coercive force Hc, saturation magnetic field Hs, and nucleating magnetic field Hn.

The hard magnetic recording layer used in the present invention is a crystalline perpendicular magnetic layer in which the axis of easy magnetization is perpendicular to the substrate. As the hard magnetic recording layer of the present invention, it is possible to use a material having an appropriate coercive force Hc and nucleating magnetic field Hn in order to suppress the generation of a reversed domain against, e.g., an external magnetic field or stray field, and having a high Ku in order to obtain a high thermal decay resistance.

An example of the hard magnetic material used in the present invention is an alloy material having a (0001)-oriented hap structure containing Co and Pt. When Co alloy crystal grains in the hap structure are oriented in the (0001) plane, the axis of easy magnetization is oriented perpendicularly to the substrate surface, thereby achieving perpendicular magnetic anisotropy. As the alloy material having the (0001)-oriented hap structure containing Co and Pt, it is possible to use, e.g., a Co—Pt—Cr-based alloy material or CoCrPt—SiO₂-based alloy material. These alloys have a high magnetocrystalline anisotropic energy and hence have a high thermal decay resistance, and can also achieve an appropriately large Ha and Hn. To further improve the magnetic characteristics, additive elements such as Ta, Cu, B, and Nd may also be added to these alloy materials as needed. Whether the hard magnetic recording layer has the (0001)-oriented hap structure can be evaluated by, e.g., the θ-2θ method by using a general X-ray diffraction apparatus (XRD). The hard magnetic recording layer can be given a granular structure to some extent. A granular structure can achieve a large Hc and Hn.

Another example of the hard magnetic material used in the present invention is a material made of crystal grains having a (001)-oriented L1₀ structure, and mainly containing a magnetic metal element and noble metal element. Fe and/or Co can be used as the magnetic metal. Pt and/or Pd can be used as the noble metal element. When given the L1₀ structure, these materials can achieve a very large Ku of 10⁷ erg/cc or more in the c-axis direction (the direction of the normal to the (001) plane). It is also possible to add proper amounts of elements such as Cu, Zn, Zr, and C and compounds such as MgO and SiO₂ to the hard magnetic recording layer, in order to improve the magnetic characteristics or electromagnetic conversion characteristics. Whether the crystal grains forming the hard magnetic recording layer have the L1₀ structure can be confirmed by a general X-ray diffraction apparatus. The L1₀ structure exists if peaks (ordered lattice diffractions) representing planes such as (001) and (003) which are not observed in a disordered face-centered cubic lattice (FCC) can be observed at diffraction angles matching the respective interplanar spacings. Whether the hard magnetic recording layer is oriented in the (001) plane can be evaluated by using, e.g., a general X-ray diffraction apparatus (XRD).

In the perpendicular magnetic recording layer of the patterned medium of the present invention, the soft magnetic recording layer made of an amorphous soft magnetic material is formed on the hard magnetic recording layer, and coupled with the hard magnetic recording layer by exchange coupling. “Amorphous” herein mentioned does not necessarily mean a complete amorphous material such as glass, and may also include a film in which fine crystal grains having a grain size of 2 nm or less are locally oriented at random. Whether the soft magnetic recording layer is amorphous can be checked by an XRD or a diffracted image obtained by a transmission electron microscope (TEM).

As the amorphous soft magnetic material, an alloy containing Co can be used. According to an embodiment of the present invention, it is also possible to use an alloy such as Co—Zr—Nb, Co—Zr—Ta, Co—B, CoTaC, FeCoB, or FeCoN as the amorphous soft magnetic material.

Whether the hard and soft magnetic recording layers are coupled by exchange coupling can be checked by, e.g., evaluating the magnetization curve of the perpendicular magnetic recording layer by a polar Kerr effect measuring apparatus. If the exchange coupling is weak, the magnetization curve has a two-stage loop shape.

The hard and soft magnetic recording layers need not be in direct contact with each other as long as they are coupled by exchange coupling.

Note that the soft magnetic material used in the present invention is a material having a coercive force of less than 1 kOe in the direction of easy magnetization. On the other hand, the hard magnetic material is a material having a coercive force of 1 kOe or more in the direction of easy magnetization.

Although the required value of the system determines the total thickness of the perpendicular magnetic recording layer, the total thickness can be 0.5 to 50 nm, and can also be 0.5 to 20 nm. If the total thickness is less than 0.5 nm, a continuous film becomes difficult to form. This often makes it impossible to obtain good magnetic recording.

The ratio of the film thickness of the soft magnetic recording layer to that of the hard magnetic recording layer can be appropriately adjusted by the balance between the coercive force Hc, nucleating magnetic field Hn, and saturation magnetic field Hs.

In the present invention, the nonmagnetic underlying layer reinforces the function of the magnetic layer as a magnetic recording medium. More specifically, the nonmagnetic underlying layer is a thin film inserted between the perpendicular magnetic recording layer and soft magnetic underlying layer, and can be a layer made of a single material system or a multilayered film made up of several layers. The main purposes of the nonmagnetic underlying layer are to reduce the c-axis orientation dispersion of the hard magnetic recording layer, and improve the magnetic characteristics, e.g., achieve an appropriate Hc and Hn.

The nonmagnetic underlying layer can be properly selected in accordance with the hard magnetic recording layer formed on it.

For example, when using an alloy material having the (0001)-oriented hcp structure containing Co and Pt as the hard magnetic recording layer, a metal or alloy material having the (0001)-oriented hcp structure can be used as the nonmagnetic underlying layer material. The use of this nonmagnetic underlying layer can improve the c-axis orientation of the hard magnetic recording layer. More specifically, it is possible to use a metal such as Ru, Ti, or Re, or an alloy such as Ru—Cr, Ru—W, or Ru—Co.

On the other hand, when using an alloy material made of crystal grains having the L1₀ structure and mainly containing a magnetic metal element and noble metal element as the hard magnetic recording layer, an amorphous alloy containing Ni can be used as the nonmagnetic underlying layer material. “Amorphous” herein mentioned does not necessarily mean a complete amorphous material such as glass, and can also include a film in which fine crystal grains having a grain size of 2 nm or less are locally oriented at random. Examples of this Ni-containing alloy are alloy systems such as Ni—Nb, Ni—Ta, Ni—Zr, Ni—W, Ni—Mo, and Ni—V. The Ni content in these alloys can be 20 to 70 at %. When the Ni content falls within this range, the alloy readily becomes amorphous. Furthermore, the surface of the amorphous alloy underlying layer containing Ni can be exposed to an ambient containing oxygen. This makes it possible to improve the c-axis orientation of the hard magnetic recording layer. One or more crystalline underlying layers made of Cr or an alloy containing Cr as a main component can be inserted between the Ni-containing amorphous alloy underlying layer and magnetic recording layer. Consequently, the c-axis orientation of the magnetic recording layer can further improve. “A main component” herein mentioned is an element having the highest atomic number ratio among elements forming the alloy. As this underlying layer, it is possible to use Cr or an alloy system such as Cr—Ti or Cr—Ru. At least one crystalline buffer layer made of at least one element or alloy selected from Pt, Pd, Ag, Cu, and Ir may also be inserted between the underlying layer made of an alloy containing Cr as a main component and the magnetic recording layer. This often further improves the c-axis orientation of the magnetic recording layer. In addition, this often accelerates the ordering of the ordered alloy of the magnetic recording layer. Consequently, the magnetic anisotropic energy often increases and raises the thermal decay resistance.

The perpendicular magnetic recording layer of the present invention is given a fine-shape array structure formed by patterning. An example of the patterning method is a method in which the medium surface is coated with a mask material such as SOG (Spin On Glass), a three-dimensional pattern is formed by nanoimprinting by using a stamper on which a dot pattern is transferred, a perpendicular magnetic recording layer is formed by etching the three-dimensional pattern by Ar ion milling, and the SOG mask is removed by reactive ion milling (RIE) using CF₄ gas. Another example is a method in which a self-organized pattern is formed on the medium surface by a self-organizing phenomenon of a PS (polystyrene)-PMMA (polymethylmethacrylate) diblock polymer and RIE using O₂ gas, the medium surface is coated with SOG, a dot-shaped mask made of SOG is formed by performing RIE using O₂ gas again, and milling is performed in the same manner as above.

After the patterning, a nonmagnetic material may also be buried in trenches between the magnetic dots.

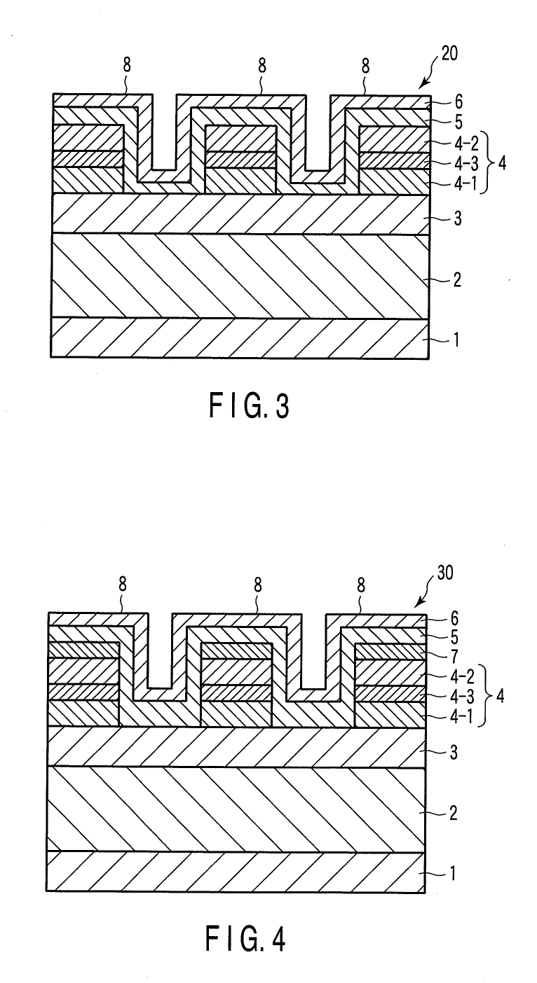

FIG. 3 is a sectional view showing another example of the perpendicular magnetic recording medium according to the present invention.

In a perpendicular magnetic recording medium 20 as shown in FIG. 3, a soft magnetic underlying layer 2, nonmagnetic underlying layer 3, perpendicular magnetic recording layer 4, protective layer 5, and lubricant layer 6 are sequentially stacked on a substrate 1, and the perpendicular magnetic recording layer 4 has a patterned fine-shape array structure. The perpendicular magnetic recording 4 includes a hard magnetic recording layer 4-1, nonmagnetic interlayer 4-3, and soft magnetic recording layer 4-2, and has an array of projections 8 similar to that shown in FIG. 1.

The thin nonmagnetic interlayer formed between the hard and soft magnetic recording layers appropriately weakens the exchange coupling force between them, thereby forming a structure similar to a so-called ECC (Exchange Coupled Composite) medium. This makes it possible to reduce the switching field.

The film thickness of the nonmagnetic interlayer can be 0.3 to 2.5 nm, and can also be 0.75 to 1.5 nm. If the nonmagnetic interlayer film thickness is 0.3 nm or less, a continuous film is difficult to form, so the effect of controlling the magnetic characteristics does not notably appear in many cases. If the nonmagnetic interlayer film thickness exceeds 2.5 nm, the exchange coupling significantly weakens, and the soft magnetic recording layer often irreversibly reverses magnetization.

The film thickness of the nonmagnetic interlayer can be evaluated by, e.g., cross-sectional TEM observation. As the nonmagnetic interlayer material, it is possible to use a metal or alloy containing at least one element selected from Pd, Pt, Cu, Ti, Ru, Re, Ir, and Cr.

FIG. 4 is a sectional view showing still another example of the perpendicular magnetic recording medium according to the present invention.

In a perpendicular magnetic recording medium 30 as shown in FIG. 4, a soft magnetic underlying layer 2, nonmagnetic underlying layer 3, perpendicular magnetic recording layer 4, cap layer 7, protective layer 5, and lubricant layer 6 are sequentially stacked on a substrate 1, and the perpendicular magnetic recording layer 4 has a patterned fine-shape array structure. The perpendicular magnetic recording layer 4 includes a hard magnetic recording layer 4-1, nonmagnetic interlayer 4-3, and soft magnetic recording layer 4-2, and has an array of projections 8 similar to that shown in FIG. 1.

In the perpendicular magnetic recording medium of the present invention, the cap layer made of a nonmagnetic metal can be formed between the soft magnetic recording layer and protective layer.

When patterning the projections by using, e.g., CF₄ gas as a process gas, magnetic elements such as Co and Fe are readily fluoridated if the amorphous soft magnetic layer is exposed to CF₄ gas. Consequently, these magnetic elements are released from the soft magnetic layer, so the soft magnetic layer partially loses its magnetism. In some cases, the soft magnetic recording layer cannot well achieve the functions as described above any longer.

When the cap layer made of a nonmagnetic metal is formed on the amorphous soft magnetic layer, the surface of the amorphous soft magnetic layer is not directly exposed to CF₄ gas. This makes it possible to suppress the release of the magnetic elements, and suppress the reduction in magnetization amount of the amorphous soft magnetic layer. Accordingly, the SFD can be further reduced. As the cap layer material as described above, it is possible to use a crystalline nonmagnetic metal or alloy material such as Cu, Au, Pd, Pt, Rh, Ir, Ru, Re, Cr, Mo, W, V, Nb, Ta, Ti, Zr, or Hf. The film thickness of the cap layer can be 0.5 to 5 nm. If the film thickness is less than 0.5 nm, the magnetic element release suppressing effect as described above does not remarkably appear. If the film thickness exceeds 5 nm, the magnetic spacing between a recording/reproduction head and the magnetic recording layer increases. This often deteriorates the OW characteristic.

Alternatively, a crystalline soft magnetic material can be used as the cap layer. The crystalline soft magnetic layer has a CF₄ gas resistance higher than that of an amorphous layer. Therefore, the crystalline soft magnetic layer suppresses the release of magnetic elements and the reduction in magnetization amount of the amorphous soft magnetic layer, thereby further reducing the SFD. In addition, since the cap layer itself has magnetism, the cap layer does not act as a magnetic spacing and hence does not deteriorate the OW characteristic. When the cap layer and soft magnetic recording layer are coupled by exchange coupling, the reproduction output and SNR further increase.

Examples of the cap layer material are crystalline metals and alloys such as Fe, Co, Ni, Fe—Co, and Ni—Fe.

The cap layer film thickness can be 0.5 to 10 nm. If the cap layer film thickness is less than 0.5 nm, the magnetic element release suppressing effect as described above does not remarkably appear. If the cap layer film thickness exceeds 10 nm, the Hn often decreases due to the demagnetizing field of the cap layer.

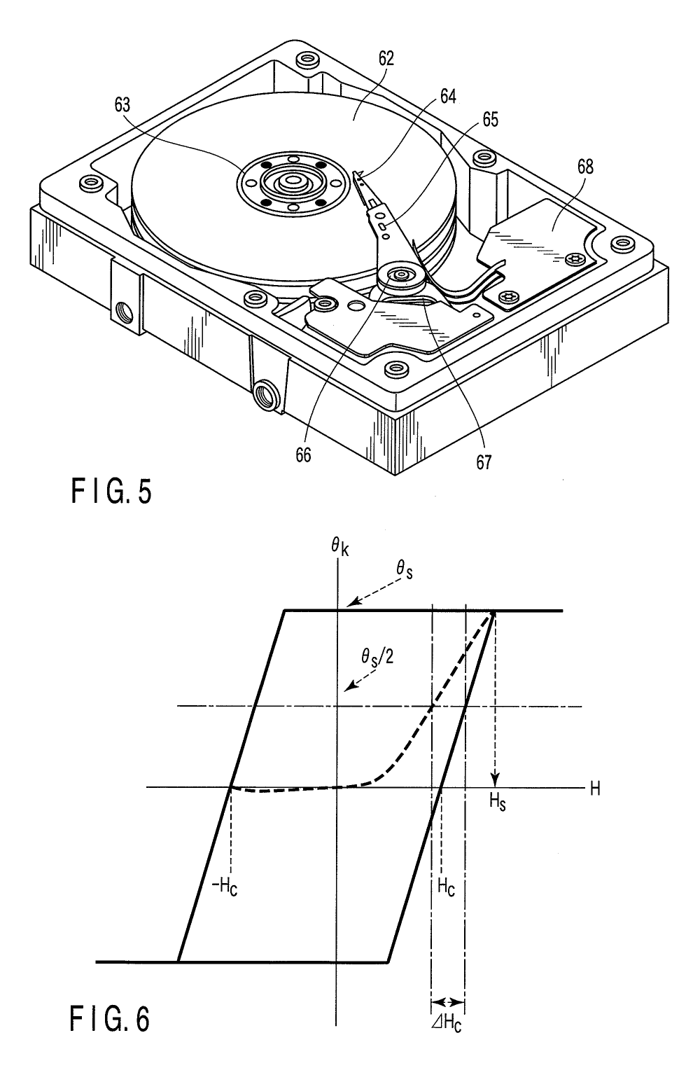

FIG. 5 is a partially exploded perspective view of an example of the magnetic recording/reproduction apparatus of the present invention.

A rigid magnetic disk 62 for recording information according to the present invention is mounted on a spindle 63, and rotated at a predetermined rotational speed by a spindle motor (not shown). A slider 64 on which a recording head for recording information by accessing the magnetic disk 62 and an MR head for reproducing information are mounted is fixed to the distal end of a suspension made of a thin leaf spring. This suspension is connected to one end of an arm 65.

A voice coil motor 67 as a kind of a linear motor is formed at the other end of the arm 65. The voice coil motor 67 comprises a driving coil (not shown) wound on the bobbin of the arm 65, and a magnetic circuit including a permanent magnet and counter yoke opposing each other to sandwich the driving coil.

Ball bearings (not shown) formed in the upper and lower portions of a fixing shaft 66 support the arm 65, and the voice coil motor 67 pivots the arm 65. That is, the voice coil motor 67 controls the position of the slider 64 on the magnetic disk 62.

The present invention will be explained in more detail below by way of its examples.

### EXAMPLE 1

A 1.8-inch hard disk type nonmagnetic glass substrate (SX manufactured by OHARA) was loaded into a vacuum chamber of the c-3010 sputtering apparatus manufactured by ANELVA.

After the vacuum chamber of the sputtering apparatus was evacuated to 1×10⁻⁵ Pa or less, a 100-nm thick Co₉₀Zr₅Nb₅ film as a soft magnetic underlying layer, a 20-nm thick Ru film as a nonmagnetic underlying layer, a 16-nm thick (Co₇₄—Cr₁₀—Pt₁₆)-8 mol % SiO₂ film as a hard magnetic recording layer, and a 6-nm thick Co₉₀Zr₅Nb₅ film as an amorphous soft magnetic recording layer were sequentially formed.

After the soft magnetic recording layer was formed, the substrate was unloaded from the sputtering apparatus. The substrate was then spin-coated with a solution prepared by dissolving a PS (polystyrene)-PMMA (polymethylmethacrylate) diblock polymer in an organic solvent, and annealed at 200° C. After that, phase-separated PMMA was removed by RIE using O₂ gas, SOG was formed by spin coating, and RIE using O₂ gas was performed again, thereby forming a dot-shaped mask made of SOG. Subsequently, a perpendicular magnetic recording layer was etched by Ar ion milling, and the SOG mask was removed by RIE using CF₄ gas. After the mask was removed, the substrate was loaded into the sputtering apparatus again, a 6-nm thick C film was formed as a protective film, and perfluoropolyether was applied as a lubricant layer by dipping, thereby forming a 45-nm pitch bit pattern array.

The Ar pressure was 0.7 Pa when forming the soft magnetic underlying layer, the soft magnetic recording layer, and C of the protective layer, and 3 Pa when forming Ru of the nonmagnetic underlying layer and (Co₇₄—Cr₁₀—Pt₁₆)-8 mol % SiO₂ of the hard magnetic recording layer. The sputtering targets used were Co₉₀Zr₅Nb₅, Ru, (Co₇₄—Cr₁₀—Pt₁₆)-8 mol % SiO₂, Ru, and C targets each having a diameter of 164 mm, and the films were formed by DC sputtering. The input power to each target was 500 W. The distance between the target and substrate was 50 mm, and all the films were formed at room temperature.

In addition, patterned media were formed following the same procedures as above by using Co₉₀Zr₅Ta₅, Co₉₅B₅, Co₉₀Ta₅C₅, Fe_{47.5}Co_{47.5}B₅, and Fe₄₉Co₄₉N₂ as soft magnetic recording layers.

### COMPARATIVE EXAMPLE 1

As a comparative example, a patterned medium having no soft magnetic recording layer was formed following the same procedures as in Example 1.

### COMPARATIVE EXAMPLE 2

As a comparative example, a patterned medium using a 6-nm thick crystalline Co film instead of an amorphous soft magnetic recording layer was formed following the same procedures as in Example 1.

### COMPARATIVE EXAMPLE 3

As a comparative example, a patterned medium using a Co/Pd artificial lattice instead of the (Co₇₄—Cr₁₀—Pt₁₆)-8 mol % SiO₂ film as a hard magnetic recording layer and having no soft magnetic recording layer was formed following the procedure described below.

After a soft magnetic underlying layer was formed in the same manner as in Example 1, a 10-nm thick Pd film was formed as a nonmagnetic underlying layer, and fifteen 0.3-nm thick Co layers and fifteen 0.7-nm thick Pd layers were stacked alternatively as a hard magnetic recording layer. After that, patterning, protective layer formation, and lubricant application were sequentially performed in the same manner as in Example 1, thereby obtaining a patterned medium.

The Ar pressure was 0.7 Pa when forming each layer. The sputtering targets used were Pd, Co, and C targets each having a diameter of 164 mm, and the films were formed by DC sputtering. The input power to each target was 100 W. The distance between the target and substrate was 50 mm, and all the films were formed at room temperature.

To check the recording stability of the magnetic dots of each obtained patterned medium, the medium was demagnetized by DC by using a spin stand and a single pole head having a recording track width of 0.3 Mm, and the magnetization configuration in the DC state was evaluated by a magnetic force microscope (MFM).

The hysteresis loop perpendicular to the film surface of the perpendicular magnetic recording layer of each patterned medium was evaluated by the BH-M800UV-HD-10 polar Kerr effect evaluating apparatus manufactured by NEOARK by using a laser source having a wavelength of 408 nm under the conditions that the maximum applied magnetic field was 20 kOe and the magnetic field sweep rate was 133 Oe/s.

The SFD of each patterned medium was evaluated by the ΔHc/Hc method using a polar Kerr effect measuring apparatus. FIG. 6 is a graph showing ΔHc and a magnetization curve for explaining a method of evaluating the ΔHc. That is, after the hysteresis loop (thick solid line) is obtained in the same manner as above, the applied magnetic field is turned to Hs from the point of −Hc on the hysteresis loop, thereby obtaining a minor loop (thick dotted line). The difference between a magnetic field that is θs/2 on the minor loop and a magnetic field in the first quadrant of the hysteresis loop is regarded as ΔHc, and ΔHc/Hc is obtained by normalization by Hc.

The crystal structure and crystal plane orientation of each medium were evaluated by the θ-2θ method by generating a Cu—Kα line at an acceleration voltage of 45 kV and a filament current of 40 mA by using the X′pert-MRD X-ray diffraction apparatus manufactured by Philips.

Results of Evaluation by X-Ray Diffraction Apparatus

In each of the media of Example 1 and Comparative Examples 1 and 2, the hard magnetic recording layer was crystalline, and the magnetic crystal grains had the hcp structure and were oriented in the (0001) plane.

Also, Ru of the nonmagnetic underlying layer of each medium had the hcp structure and was oriented in the (0001) plane.

The hard magnetic recording layer of Comparative Example 3 formed an artificial lattice made of crystalline Co and Pd.

The soft magnetic recording layer of Example 1 was amorphous.

The Co soft magnetic recording layer of Comparative Example 2 was crystalline, had the hcp structure, and was oriented in the (0001) plane.

When the magnetization configuration after DC demagnetization was observed with the MFM, reversed domains were generated in 267 dots among 1,000 dots in Comparative Example 1, whereas no reversed domain was found in any of 1,000 dots in each of the media of Example 1 and Comparative Examples 2 and 3.

Table 1 below shows the SFD evaluation results.

TABLE 1

| Medium | [symbol] Hc/Hc |
|---|---|
| Example 1 | 0.22 |
| Soft magnetic | |
| recording layer: CoZrNb | |
| Example 1 | 0.22 |
| Soft magnetic | |
| recording layer: CoZrTa | |
| Example 1 | 0.2 |
| Soft magnetic | |
| recording layer: CoB | |
| Example 1 | 0.23 |
| Soft magnetic | |
| recording layer: CoTaC | |
| Example 1 | 0.19 |
| Soft magnetic | |
| recording layer: FeCoB | |
| Example 1 | 0.2 |
| Soft magnetic | |
| recording layer: FeCoN | |
| Comparative Example 1 | 0.82 |
| Comparative Example 2 | 0.72 |
| Comparative Example 3 | 0.71 |

The above table shows that the ΔHc/Hc value and SFD greatly reduced in the patterned medium of Example 1, compared to those of Comparative Examples 1, 2, and 3.

### EXAMPLE 2

After layers up to a soft magnetic underlying layer were formed following the same procedures as in Example 1, a 5-nm thick Ni₆₀Ta₄₀ film was formed as a nonmagnetic underlying layer. After that, the substrate was heated to 280° C. by using an infrared lamp heater, and the surface of the nonmagnetic underlying layer was exposed to an oxygen ambient at 5×10⁻³ Pa for 10 sec. Subsequently, a 5-mm thick Cr film, 10-nm thick Pt film, 10-nm thick Fe₄₇Pt₅₃ film, and 6-nm thick Co₉₀Zr₅Nb₅ film were respectively formed as a nonmagnetic underlying layer 2, nonmagnetic underlying layer 3, hard magnetic recording layer, and soft magnetic recording layer.

After that, a 45-nm pitch bit pattern array was formed in the same manner as in Example 1, and protective layer formation and lubricant application were sequentially performed, thereby obtaining a 45-nm pitch bit pattern medium.

The Ar pressure was 0.7 Pa when forming the soft magnetic underlying layer, the nonmagnetic underlying layer 1, the nonmagnetic underlying layer 2, the soft magnetic recording layer, and C of the protective layer, and 8 Pa when forming Pt of the nonmagnetic underlying layer 3 and Fe₅₀Pt₅₀ of the hard magnetic recording layer. The sputtering targets used were Co₉₀Zr₅Nb₅, Ni₆₀Ta₄₀, Cr, Pt, Fe₅₀Pt₅₀, Co₉₀Zr₅Nb₅, and C targets each having a diameter of 164 mm, and the films were formed by DC sputtering. The input power to each target was 500 W. The distance between the target and substrate was 50 mm.

Results of XRD Evaluation

The hard magnetic recording layer was crystalline, and the magnetic crystal grains had the L1₀ structure and were oriented in the (001) plane.

Also, the soft magnetic recording layer and nonmagnetic underlying layer 1 were amorphous.

When the magnetization configuration after DC demagnetization was observed with the MFM, no reversed domain was found in any of 1,000 dots.

Table 2 below shows the SFD evaluation result. The ΔHc/Hc value and SFD greatly reduced in the patterned medium of Example 2 as well.

TABLE 2

| Medium | [symbol] Hc/Hc |
|---|---|
| Example 2 | 0.17 |

### EXAMPLE 3

After films up to a hard magnetic recording layer were formed following the same procedures as in Example 1, 0.1- to 3-nm thick Pd films were formed as nonmagnetic interlayers. After that, soft magnetic recording layer formation, 45-nm pitch bit pattern array formation, protective layer formation, and lubricant application were sequentially performed in the same manner as in Example 1, thereby obtaining various kinds of patterned media.

The Ar pressure was 0.7 Pa when forming the nonmagnetic interlayers, the sputtering targets used were Pd targets each having a diameter of 164 mm, and the films were formed by DC sputtering. The input power to each target was 100 W. All the films were formed at room temperature.

In addition, media using Pt, Cu, Ti, Ru, Re, Ir, and Cr as nonmagnetic interlayers were formed following the same procedures as above.

When evaluation was performed by the X-ray diffraction apparatus, the hard magnetic recording layers were crystalline, and the magnetic crystal grains had the hcp structure and were oriented in the (0001) plane.

Also, Ru of the nonmagnetic underlying layers had the hcp structure and was oriented in the (0001) plane.

The soft magnetic recording layers were amorphous.

Table 3 below shows the SFD evaluation results and the values of Hc and Hs when the nonmagnetic interlayers were made of Pd. Note that the row in which the nonmagnetic interlayer is 0 nm in Table 3 indicates Example 1.

In each of the patterned media in which the interlayer film thickness was 2.5 nm or less, the ΔHc/Hc value remained small, and no increase in SFD was found. On the other hand, when the nonmagnetic interlayer film thickness was 0.3 to 2.5 nm, Hc and Hs reduced, so it was possible to reduce the demagnetizing field.

Similar tendencies were found when the interlayer materials were Pt, Cu, Ti, Ru, Re, Ir, and Cr.

TABLE 3

| Nonmagnetic | | | |
|---|---|---|---|
| interlayer film | | | |
| thickness (nm) | [symbol] Hc/Hc | Hc | Hs |
| 0 | 0.22 | 5.2 | 9.8 |
| 0.1 | 0.23 | 5.2 | 9.7 |
| 0.3 | 0.23 | 4.7 | 8 |
| 0.5 | 0.25 | 4.5 | 7.8 |
| 1 | 0.24 | 4.4 | 7.8 |
| 1.5 | 0.26 | 4.3 | 7.6 |
| 2 | 0.26 | 4.5 | 7.7 |
| 2.5 | 0.28 | 4.7 | 8.1 |
| 3 | 0.66 | 5.7 | 10.2 |

### EXAMPLE 4

After films up to a soft magnetic recording layer were formed following the same procedures as in Example 1, a 3-nm thick Ru film was formed as a nonmagnetic cap layer. After that, a 45-nm pitch bit pattern array was formed in the same manner as in Example 1, and protective layer formation and lubricant application were sequentially performed, thereby obtaining various kinds of patterned media.

When forming the Ru film as the nonmagnetic cap layer, the Ar pressure was 0.7 Pa, the sputtering target used was an Ru target having a diameter of 164 mm, and the film was formed by DC sputtering. The input power to each target was 500 W. All the films were formed at room temperature.

In addition, patterned media having nonmagnetic cap layers made of Cu, Au, Pd, Pt, Rh, Ir, Re, Cr, Mo, W, V, Nb, Ta, Ti, Zr, and Hf were formed following the same procedures as above.

When each medium was evaluated using the X-ray diffraction apparatus, the hard magnetic recording layer was crystalline, and the magnetic crystal grains had the hcp structure and were oriented in the (0001) plane.

Also, Ru of the nonmagnetic underlying layer had the hcp structure and was oriented in the (0001) plane.

The soft magnetic recording layer was amorphous.

Furthermore, each nonmagnetic cap layer was crystalline.

Table 4 below shows the SFD evaluation result of each medium.

TABLE 4

| Nonmagnetic | |
|---|---|
| cap layer | [symbol] Hc/Hc |
| Ru | 0.10 |
| Cu | 0.11 |
| Au | 0.13 |
| Pd | 0.09 |
| Pt | 0.10 |
| Rh | 0.15 |
| Ir | 0.14 |
| Re | 0.15 |
| Cr | 0.11 |
| Mo | 0.13 |
| W | 0.11 |
| V | 0.10 |
| Nb | 0.12 |
| Ta | 0.09 |
| Ti | 0.15 |
| Zr | 0.12 |
| Hf | 0.12 |

The above table shows that when compared to Example 1, the ΔHc/Hc value reduced and the SFD greatly reduced because the nonmagnetic cap layer was stacked in Example 4.

### EXAMPLE 5

After films up to a soft magnetic recording layer were formed following the same procedures as in Example 1, a 3-nm thick Ni film was formed as a soft magnetic cap layer. After that, a 45-nm pitch bit pattern array was formed in the same manner as in Example 1, and protective layer formation and lubricant application were sequentially performed, thereby obtaining various kinds of patterned media.

When forming the Ni film as the soft magnetic cap layer, the Ar pressure was 0.7 Pa, the sputtering target used was an Ni target having a diameter of 164 mm, and the film was formed by DC sputtering. The input power to each target was 500 W. All the films were formed at room temperature.

In addition, patterned media having soft magnetic cap layers made of Co, Fe, CoFe, CoNi, and NiFe were formed following the same procedures as above.

When each medium was evaluated using the X-ray diffraction apparatus, the hard magnetic recording layer was crystalline, and the magnetic crystal grains had the hcp structure and were oriented in the (0001) plane.

Also, Ru of the nonmagnetic underlying layer had the hcp structure and was oriented in the (0001) plane.

The soft magnetic recording layer was amorphous.

Furthermore, each soft magnetic cap layer was crystalline.

When the magnetization configuration after DC demagnetization was observed with the MFM, no reversed domain was found in any of 1,000 dots.

Table 5 below shows the SFD evaluation results.

TABLE 5

| Soft magnetic | |
|---|---|
| cap layer | [symbol] Hc/Hc |
| Ni | 0.08 |
| Co | 0.1 |
| Fe | 0.14 |
| CoFe | 0.11 |
| CoNi | 0.12 |
| NiFe | 0.11 |

Table 5 reveals that the ΔHc/Hc value and SFD reduced compared to Example 1.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate;
a soft magnetic underlying layer formed on the substrate;
at least one nonmagnetic underlying layer formed on the soft magnetic underlying layer; and
a perpendicular magnetic recording layer formed on the nonmagnetic underlying layer, comprising a crystalline hard magnetic recording layer having magnetic anisotropy in a film thickness direction, and an amorphous soft magnetic recording layer formed on the hard magnetic recording layer, and having an array of magnetic structures each corresponding to one bit of recording information, the hard magnetic recording layer and the soft magnetic recording layer being coupled by exchange coupling.

2. The medium of claim 1, wherein the soft magnetic recording layer is made of an amorphous alloy mainly containing cobalt.

3. The medium Of claim 2, wherein the soft magnetic recording layer is made of at least one alloy selected from a group consisting of a Co—Zr—Nb alloy, a Co—Zr—Ta alloy, a Co—B alloy, a Co—Ta—C alloy, an Fe—Co—B alloy, and an Fe—Co—N alloy.

4. The medium of claim 1, wherein the hard magnetic recording layer is made of a (0001)-oriented alloy material containing cobalt and platinum and having an hcp structure.

5. The medium of claim 4, wherein the nonmagnetic underlying layer is made of one of ruthenium and an alloy containing ruthenium.

6. The medium of claim 1, wherein the hard magnetic recording layer is made of a (001)-oriented alloy material containing at least one element selected from a group consisting of iron and cobalt, and at least one element selected from a group consisting of platinum and palladium, having an L1₀ structure.

7. The medium of claim 6, wherein at least one layer of the at least one nonmagnetic underlying layer is made of an amorphous alloy containing nickel.

8. The medium of claim 1, further comprising a nonmagnetic interlayer formed between the hard magnetic recording layer and the soft magnetic recording layer, and having a thickness of 0.3 to 2.5 nm.

9. The medium of claim 8, wherein the nonmagnetic interlayer contains at least one of palladium, platinum, copper, titanium, ruthenium, rhenium, iridium, and chromium.

10. The medium of claim 1, further comprising a cap layer formed on the soft magnetic recording layer and made of a crystalline nonmagnetic metal material.

11. The medium of claim 10, wherein the nonmagnetic metal material is made of one of a metal and alloy containing at least one of copper, gold, palladium, platinum, rhodium, iridium, ruthenium, rhenium, chromium, molybdenum, tungsten, vanadium, niobium, tantalum, titanium, zirconium, and hafnium.

12. The medium of claim 1, further comprising a cap layer formed on the soft magnetic recording layer, and made of a crystalline soft magnetic material containing at least one of cobalt, nickel, and iron.

13. The medium of claim 12, wherein the cap layer made of the crystalline soft magnetic material is made of at least one material selected from a group consisting of cobalt, iron, nickel, cobalt iron, cobalt nickel, and nickel iron.

14. A magnetic recording/reproduction apparatus comprising:
a recording/reproduction head; and
a perpendicular magnetic recording medium comprising a substrate, a soft magnetic underlying layer formed on the substrate, at least one nonmagnetic underlying layer formed on the soft magnetic underlying layer, and a perpendicular magnetic recording layer formed on the nonmagnetic underlying layer, comprising a crystalline hard magnetic recording layer having magnetic anisotropy in a film thickness direction, and an amorphous soft magnetic recording layer formed on the hard magnetic recording layer, and having an array of magnetic structures each corresponding to one bit of recording information, the hard magnetic recording layer and the soft magnetic recording layer being coupled by exchange coupling.

15. The apparatus of claim 14, wherein the soft magnetic recording layer is made of an amorphous alloy mainly containing cobalt.

16. The apparatus of claim 15, wherein the soft magnetic recording layer is made of at least one alloy selected from a group consisting of a Co—Zr—Nb alloy, a Co—Zr—Ta alloy, a Co—B alloy, a Co—Ta—C alloy, an Fe—Co—B alloy, and an Fe—Co—N alloy.

17. The apparatus of claim 14, wherein the hard magnetic recording layer is made of a (0001)-oriented alloy material containing cobalt and platinum and having an hcp structure.

18. The apparatus of claim 17, wherein the nonmagnetic underlying layer is made of one of ruthenium and an alloy containing ruthenium.

19. The apparatus of claim 14, wherein the hard magnetic recording layer is made of a (001)-oriented alloy material containing at least one element selected from a group consisting of iron and cobalt, and at least one element selected from a group consisting of platinum and palladium, and having an L1₀ structure.

20. The apparatus of claim 19, wherein at least one layer of the at least one nonmagnetic underlying layer is made of an amorphous alloy containing nickel.

21. The apparatus of claim 14, further comprising a nonmagnetic interlayer formed between the hard magnetic recording layer and the soft magnetic recording layer, and having a thickness of 0.3 to 2.5 nm.

22. The apparatus of claim 21, wherein the nonmagnetic interlayer contains at least one of palladium, platinum, copper, titanium, ruthenium, rhenium, iridium, and chromium.

23. The apparatus of claim 14, further comprising a cap layer formed on the soft magnetic recording layer and made of a crystalline nonmagnetic metal material.

24. The apparatus of claim 23, wherein the nonmagnetic metal material is made of one of a metal and alloy containing at least one of copper, gold, palladium, platinum, rhodium, iridium, ruthenium, rhenium, chromium, molybdenum, tungsten, vanadium, niobium, tantalum, titanium, zirconium, and hafnium.

25. The apparatus of claim 14, further comprising a cap layer formed on the soft magnetic recording layer, and made of a crystalline soft magnetic material containing at least one of cobalt, nickel, and iron.

26. The apparatus of claim 25, wherein the cap layer made of the crystalline soft magnetic material is made of at least one material selected from a group consisting of cobalt, iron, nickel, cobalt iron, cobalt nickel, and nickel iron.
